(19) United States
(12) Patent Application Publication
(10) Pub. No.: US 2010/0083370 A1
(43) Pub. Date: Apr. 1, 2010

(54) SYSTEM AND METHOD FOR DYNAMIC CYPHER AUTHENTICATION

(75) Inventor: Li-Shing Chen, Hsinchu (TW)

Correspondence Address: APEX JURIS, PLLC, 12733 LAKE CITY WAY NORTHEAST, SEATTLE, WA, 98125, US

(73) Assignee: MITAC TECHNOLOGY CORP., Hsinchu (TW)

(21) Appl. No.: 12/239,406

(22) Filed: Sep. 26, 2008

(51) Int. Cl. H04L 9/32; G06F 7/04

(52) U.S. Cl. 726/19

(57) ABSTRACT

A dynamic cypher authentication system is applied to an electronic device having an authentication password. The system includes an input module, a password triggering module, an operation module, and an authentication module. The input module receives an operator password input by a user. The password triggering module generates a trigger signal and then generates a prompt password according to the trigger signal. The operation module performs a mathematical operation on the prompt password according to the operator password, so as to generate the authentication password. The authentication module receives a login password and compares the login password with the authentication password, so as to determine whether to authorize a login request on the electronic device.

### BACKGROUND OF THE INVENTION

1. Field of the Invention

The present invention relates to electronic authentication technology, and in particular, to a dynamic cypher authentication system and method.

2. Related Art

Ordinary electronic products all have functions that require users to input passwords for authentication before users intend to us the electronic products to use the electronic products or access data, thereby ensuring that only an authorized user can successfully log in the electronic product.

Conventionally, the password is fixed. The passwords merely consisting of numerals or letters, or alphanumeric passwords formed by combining numerals and letters are all set and changed by the users themselves, and thus large potential safety hazards still exist. This is because that in practice, users do not often change the passwords, and a fairly large proportion of users use same passwords for a long time. In this case, once the passwords are known or cracked by others, unauthorized users are able to log in the electronic devices and then embezzle the electronic devices or steal data, thereby resulting in loss of the users.

Some relatively advanced safety authentication systems provide assistant authentications, such as iris recognition and fingerprint recognition. However, ordinary customers do not often come in contact with such systems. One of commonly used mechanisms for logging in a website on the Internet is receiving a password contained in a short message by another apparatus such as a cell phone. For ordinary customers, the above two password authentication modes are not frequently used and require the user to possess operating skills to some degree due to high difficulty, and are thus inconvenient for use.

Therefore, there is a need to solve security problems derived from using the fixed password in the prior art and providing a simpler operation mode.

### SUMMARY OF THE INVENTION

According to the technical problems mentioned above, the present invention provides dynamic cypher authentication system applied to an electronic device that has an authentication password. The system allows the user to input an operator password. Then the system generates a prompt password and performs a mathematical operation on the prompt password according to the operator password, so as to generate an authentication password. The system then receives a login password input by the user and compares the login password with the authentication password, so as to determine whether to authorize the user's authentication to the electronic device.

In an embodiment of the present invention, a dynamic cypher authentication system is applied to an electronic device having an authentication password. The dynamic cypher authentication system comprises: an input module, receiving an operator password input by a user; a password triggering module, generating a trigger signal and then generating a prompt password according to the trigger signal; an operation module, performing a mathematical operation on the prompt password according to the operator password, so as to generate the authentication password; and an authentication module, receiving a login password and comparing the login password with the authentication password, so as to determine whether to allow a login request of the user to log in the electronic device.

In another embodiment of the present invention, a dynamic cypher authentication method is applicable to an electronic device having an authentication password. The method comprising the following steps: receiving an operator password; generating a prompt password according to a trigger signal; performing a mathematical operation on the prompt password according to the operator password, so as to generate the authentication password; and receiving a login password and comparing the login password with the authentication password, so as to determine whether to allow a login request on the electronic device.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 is a schematic view of a dynamic cypher authentication system according to a first embodiment;

FIG. 2A is a schematic view of a dynamic cypher authentication system according to a second embodiment;

FIG. 2B is a schematic view of an embodiment of an output screen of FIG. 2A;

FIG. 3A is a first schematic view of a dynamic cypher authentication system according to a third embodiment;

FIG. 3B is a second schematic view of a dynamic cypher authentication system according to the third embodiment;

FIG. 4A is a schematic view of a dynamic cypher authentication system according to a fourth embodiment;

FIG. 4B is a schematic view of an embodiment of an output screen of FIG. 4A; and

FIG. 5 is a flow chart of processes of a dynamic cypher authentication method.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

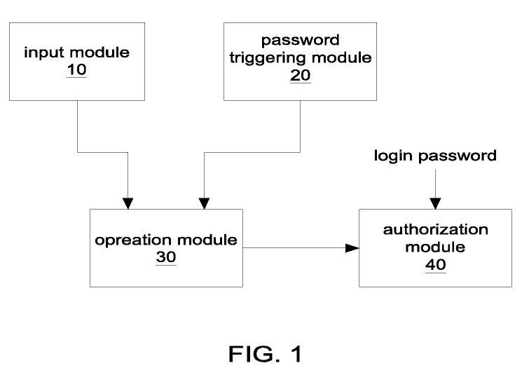

Referring to FIG. 1, a schematic view of a dynamic cypher authentication system according to a first embodiment is shown. Referring to FIG. 1, the dynamic cypher authentication system of the present invention is applied in an electronic device having an authentication password. The dynamic cypher authentication system includes an input module 10, a password triggering module 20, an operation module 30, and an authentication module 40.

The input module 10 receives inputs by a user. An operator password is input through the input module for recordation in advance. Such operator password is used as an assistant exclusive password to obtain the authentication password. The operator password includes at least one operator or at least one operation number, or a combination of the operator and the operation number. The detail of the operator password will be described below. In the present invention, an operator is defined as the fundamental operators of arithmetic, while the operation number is defined as the numeric number calculable by said operator.

The password triggering module 20 generates a trigger signal, upon the user's input operation after the recordation of the operator password; and then the password triggering module 20 generates a prompt password according to the trigger signal. The password triggering module 20 can be one of the buttons of the electronic device, such as the buttons on a keyboard, or a touch panel allowing input operation thereon. That is, when a default or user-defined button of the electronic device is pressed, a prompt password is automatically generated by the password triggering module 20.

The operation module 30 performs a mathematical operation on the prompt password according to the operator password set by the user, so as to generate the authentication password. The authentication password is a dynamic exclusive password for the user to log in the electronic device. According to the various prompt passwords generated upon the user's log in operation every time, and through the mathematical operation of the prompt password and the pre-recorded operator passwords, the authentication password varies every time. If the user intends to log in the electronic device, he must do the same mathematical operation (including the combination of the prompt password and the pre-recorded operator passwords) by himself and his input password must be identical to the authentication password of the system, only by which can the electronic device allow for login. Therefore, the authentication password can be used to identify whether the user is an authorized one.

The operator password may either be simply applied to each number of the prompt password or be used together with an “operation rule”. Namely, in a mathematical operation, there can be only the operator password applied to the prompt password for calculation, or alternatively using them together with the operation rule (will be further explain in the examples below). Basically, the operation rule defines how the operator password will operate on the prompt password. To be practical for general users, the pre-recorded operator password and the operation rule of the mathematical operation may be set as simple as possible. Certainly, for advanced users, the system may be utilized in a more complex way.

Finally, the authentication module 40 receives a login password input by the user that intends to log in the electronic device, and the authentication module 40 determines whether the login password is identical to the authentication password. If the login password and the authentication password are identical, the authentication module 40 allows the user's login request to log in the electronic device; otherwise, the user's login request is rejected.

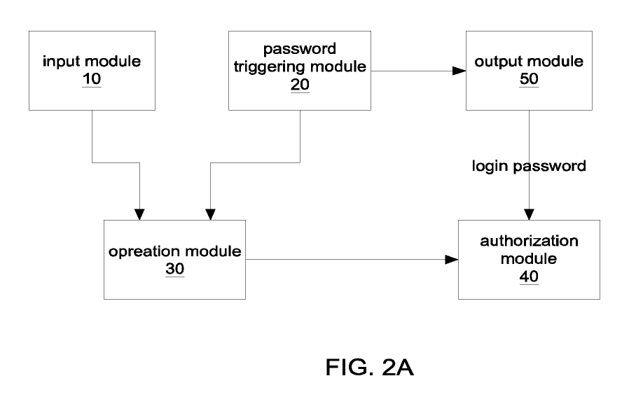

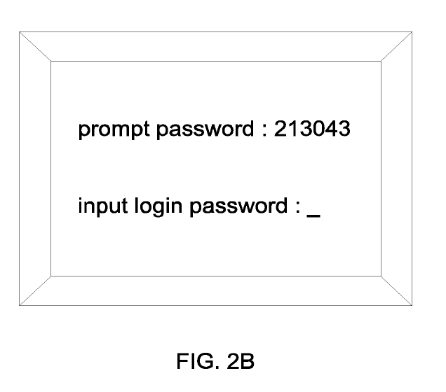

FIG. 2A is a schematic view of a dynamic cypher authentication system according to a second embodiment of the present invention. In the second embodiment, the system further includes an output module 50. The output module 50 outputs the prompt password, so as to enable the user to input the login password according to the prompt password. For example, assuming that the operator password originally input by the user via the input module 10 is an addition operator and two adjacent numbers are set to be added together. When the user intends to generate a prompt password, a trigger signal is generated simply by pressing a certain button in the electronic device. Assuming that the time at which the trigger signal is generated by pressing the button by the user is 21:30:43. At this point, a number “213043” corresponding to 21:30:43 is the prompt password. Therefore, the prompt password can be a number corresponding to the time at which the trigger signal is generated.

Then, the operation module 30 performs a mathematical operation on the prompt password according to the preset operator password (addition operator “+”, in which the operation rule is that two adjacent numbers are added together), so as to generate the authentication password. The operational result is “34347” (2+1, 1+3, 3+0, 0+4, and 4+3). In this case, the result “34347” obtained after the operation by the operation module 30 is the authentication password. If the operation password is +1 and the operation rule is to apply the operator password to each number of the prompt password “213043” (namely every number plus 1), the mathematical operation will be (2+1, 1+1, 3+1, 0+1, 4+1 and 3+1). And the authentication password will be 323154. It is noted that the first authentication password “34347” has 5 numbers, yet the second one “323154” has six. The present invention provides much more security since the numbers of the authentication password every time varies. Furthermore, the operation rule of the present invention may be provided by the system as preset options, upon the user's operation of settings. These options of operation rules may be output and shown on an output device like a display and allow the user to select a preferred one.

Afterward, when a user intends to log in the electronic device, the electronic device first outputs the prompt password via the output module 50, as shown in FIG. 2B, so as to enable the user to input the login password according to the prompt password. If the user is an authorized one, it is certain that he/she knows the originally set operator password. When the user views the prompt password, he/she can input a login password matching the authentication password by the use of the prompt password together with the originally set operator password, and thus the login request is allowed to log in the electronic device, thereby using the electronic device or accessing data stored in the electronic device.

The aforementioned prompt password is not limited to the number corresponding to the time at which the trigger signal is generated. For another example, the user also inputs an operator password via the input module 10. Assuming that the operator password includes an addition operator (+) and a subtraction operator (−) with “2” as the operation number; and meanwhile, an “operation rule” is set as “the addition operator and the subtraction operator are used alternately”. At this point, the prompt password generated by the password triggering module 20 is set to be a random number randomly selected from a random number table, and here assumed to be “567432”. The operation module 30 performs a mathematical operation on the prompt password according to the operator password and the operation rule and obtains an authentication password “749250” (5+2, 6−2, 7+2, 4−2, 3+2, and 2−2). Likewise, the output module 50 outputs the prompt password “567432”, so as to allow the user to finish his calculation and input the login password according to the prompt password together with the originally set operator password and operation rule.

The aforementioned operator password set by the user via the input module 10 is variable. Besides the above examples, various operation combinations can be used, like performing mathematical operation on the prompt password from the last number to the first number, performing mathematical operation in an interval of n numbers (n is a positive integer), or performing mathematical operation with more operators or more operation numbers. Therefore in the present invention, from the user's perspective, the user will need to preset an operation rule with the so-called operator password in the system and memorize them, instead of memorizing a fixed password as in the prior art. As long as the user memorizes a set of operator passwords set by him/her, a plurality of different authentication passwords can be derived according to different prompt passwords generated by the password triggering module 20.

In addition, in order to frequently change the authentication password, the password triggering module 20 can be set to be a button or a user interface in the electronic device for turning off (turning on) the electronic device. That is to say, each time when the user turns off (turns on) the electronic device, a trigger signal is automatically generated so as to generate a prompt password. In this manner, the user can obtain a new authentication password without particularly pressing a certain button in order to generate a new prompt password, since the electronic device automatically generates a new prompt password each time when being turned off (turned on). For the user, as long as he/she memorizes the originally set operator password, a correct login password is easy to be calculated no matter how the prompt password changes. If the prompt password uses a number corresponding to the time at which the trigger signal is generated as described above, even an authentication password that almost changing in every second can be achieved. Therefore, compared with the prior art in which the fixed password is used, the present invention greatly improves the secrecy of the password.

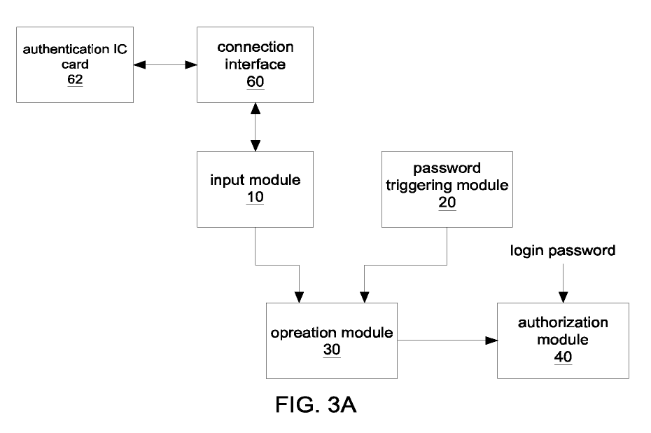

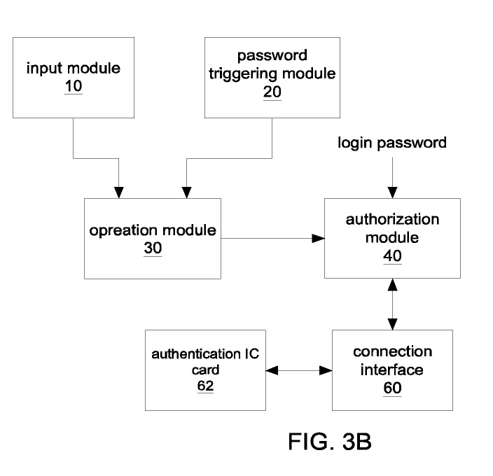

FIG. 3A is a first schematic view of a dynamic cypher authentication system according to a third embodiment. Referring to FIG. 3A, in the third embodiment, a connection interface 60 is further provided. In order to further enhance the security mechanism of the password, in this embodiment, the connection interface 60 is used to couple an authentication IC (Integrated Circuit) card 62, and the input module 10 is provided for inputting the operator password according to the authentication IC card 62. Since the operator password is one of the important elements in calculating the authentication password, the operator password needs to be protected from being changed by an illegal user. Therefore, if it is desired to change the operator password, the authentication IC card 62 only possessed by the legal user has to be coupled to the electronic device via the connection interface 60, and the input module 10 allows the user to set the operator password only after determining that the authentication IC card 62 exists.

FIG. 3B is a second schematic view of a dynamic cypher authentication system according to the third embodiment. Referring to FIG. 3B, the authentication IC card 62 is also coupled to the electronic device via the connection interface 60. The authentication module 40 not only compares the login password with the authentication password, but further determines whether the authentication IC card 62 is connected. Only when the login password matches the authentication password and it is determined that the authentication IC card 62 is connected, can the user be allowed to log in the electronic device. Therefore, the security mechanism is further enhanced.

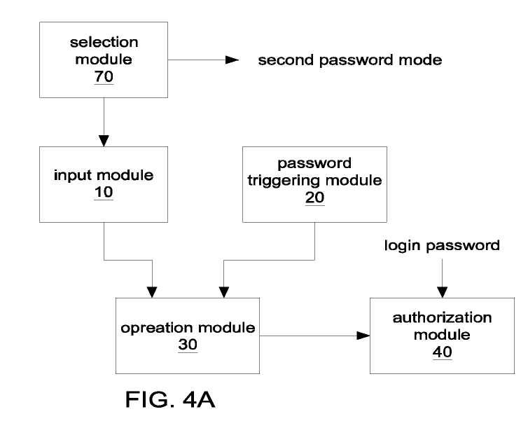

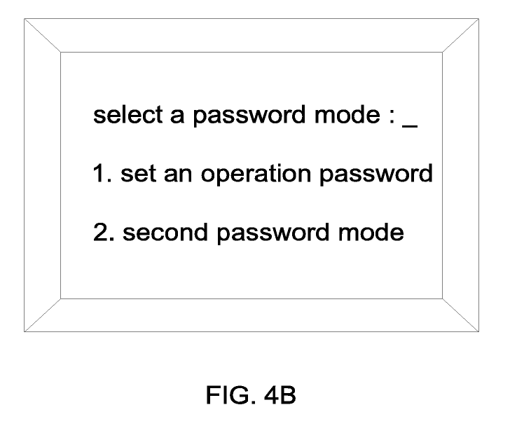

FIG. 4A is a schematic view of a dynamic cypher authentication system according to a fourth embodiment. Referring to FIG. 4A, in the fourth embodiment, a selection module 70 is further provided. The selection module 70 may be provided for the user to select setting the operator password or a second password mode. The second password mode is provided for inputting a fixed password. That is to say, the selection module 70 allows the user to select the password mode to be used by him/her, thereby satisfying different requirements of various users.

Referring to FIG. 4B, it can be seen that the output screen notifies the user to select a required password mode, for example, (1) sett an operator password, and (2) second password mode. When the user selects (1), the operator password described above is selected to be used as the password protection mode of the electronic device. Therefore, the user is first required to input the operator password, in order to perform subsequent actions. On the other hand, when the user selects (2), the second password mode is entered. That is to say, a fixed password is input by the user and used as the password protection mode of the electronic device. According to aforesaid “operation rules” mentioned in Paragraphs [0024], [0027], [0029]-[0030], several options of operation rules may be shown to the user for pre-settings if the operation password is set by the user. Sure the operation rule is possible to be set before the operator password. An optional way is to set a default operation rule as “applying the operator password to each of the prompt password”. Then the user will be not necessary to go through the settings of the operation rule.

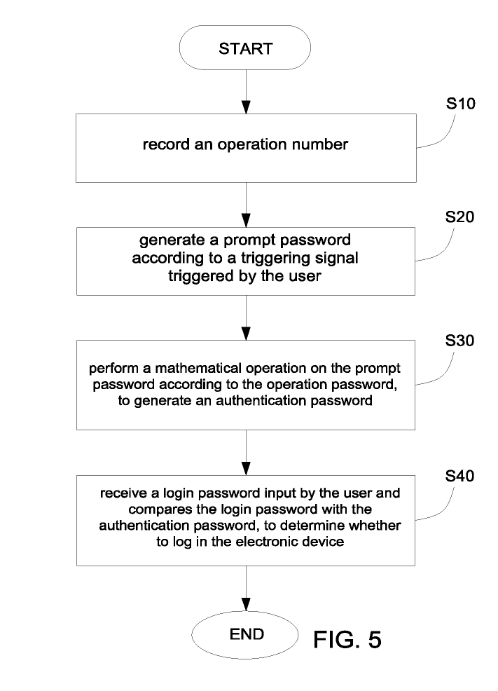

FIG. 5 is a flow chart of a dynamic cypher authentication method. Referring to FIG. 5, the dynamic cypher authentication method is applied to an electronic device having an authentication password, and includes the following steps. All technology details have been clearly disclosed in the above dynamic cypher authentication system, including the embodiments and FIGS. 1-4B.

In Step S10, the input module 10 receives and the dynamic cypher authentication system records an operator password preset by a user. The operator password includes at least one operator, or at least one operation number or a combination of the operator and the operation number. In some cases, an operation rule may be preset together with the operator password. The operation rule defines how the operator password operates on the prompt password upon performing the mathematical operation.

In Step S20, the password triggering module 20 generates a prompt password according to a trigger signal triggered by the user. The prompt password may be generated according to a number corresponding to the time at which the trigger signal is generated.

In Step S30, The operation module 30 performs a mathematical operation on the prompt password according to the operator password, so as to generate the authentication password;

In Step S40, the authentication module 40 receives a login password input by the user and compares the login password with the authentication password, so as to determine whether allow a login request on the electronic device. The login password may be generated by outputting the prompt password, and enabling a user to input the login password according to the prompt password.

In order to further enhance the security mechanism of the password, Step S10 may further include the following steps: coupling an authentication IC card, and receiving the operator password according to the authentication IC card; alternatively, coupling an authentication IC card, and determining whether to log in the electronic device according to the authentication IC card. That is to say, the legal user must possess the authentication IC card in order to freely change the operator password. Alternatively, the electronic device can be logged in only by using the authentication IC.

Besides the above steps, the dynamic cypher authentication method may further include selecting setting the operator password or a second password mode by a user. The second password mode is provided for inputting a fixed password. Therefore, the user is enabled to select different required password modes by him/her.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A dynamic cypher authentication system, applied to an electronic device having an authentication password, the dynamic cypher authentication system comprising:
an input module receiving inputs by a user, wherein an operator password being input through the input module for recordation in advance;
a password triggering module, upon the user's input operation after the recordation of the operator password, generating a trigger signal and then generating a prompt password according to the trigger signal;
an operation module, performing a mathematical operation on the prompt password according to the recorded operator password, so as to generate the authentication password; and
an authentication module, receiving a login password input by the user and comparing the login password with the authentication password, so as to determine whether to allow a login request of the user to log in the electronic device.

2. The dynamic cypher authentication system as claimed in claim 1, wherein the operator password comprises at least one operator, or at least one operation number or a combination of the operator and the operation number.

3. The dynamic cypher authentication system as claimed in claim 1, wherein an operation rule is preset together with the operator password, the operation rule defining how the operator password operates on the prompt password upon performing the mathematical operation.

4. The dynamic cypher authentication system as claimed in claim 1, wherein the password triggering module comprises a button of the electronic device.

5. The dynamic cypher authentication system as claimed in claim 1, wherein the prompt password is a number corresponding to a time at which the trigger signal is generated.

6. The dynamic cypher authentication system as claimed in claim 1, further comprising:
an output module, outputting the prompt password, so as to enable the user to input the login password according to the prompt password.

7. The dynamic cypher authentication system as claimed in claim 1, further comprising:
a connection interface, for an authentication IC (Integrated Circuit) card to be connected to, wherein the input module provides the operator password according to the authentication IC card.

8. The dynamic cypher authentication system as claimed in claim 1, further comprising:
a connection interface, for an authentication IC card to be connected to, wherein the authentication module determines whether to authorize the login request on the electronic device according to the authentication IC card.

9. The dynamic cypher authentication system as claimed in claim 1, further comprising:
a selection module, provided for the user to select setting the operator password or a second password mode.

10. The dynamic cypher authentication system as claimed in claim 9, wherein the second password mode is provided for inputting a fixed password.

11. A dynamic cypher authentication method, applicable to an electronic device having an authentication password, the method comprising the steps of:
recording an operator password preset by a user;
generating a prompt password according to a trigger signal triggered by the user;
performing a mathematical operation on the prompt password according to the operator password, so as to generate the authentication password; and
receiving a login password input by the user and comparing the login password with the authentication password, so as to determine whether to allow a login request on the electronic device.

12. The dynamic cypher authentication method as claimed in claim 11, wherein the operator password comprises at least one operator, or at least one operation number or a combination of the operator and the operation number.

13. The dynamic cypher authentication method as claimed in claim 11, wherein an operation rule is preset together with the operator password, the operation rule defining how the operator password operates on the prompt password upon performing the mathematical operation.

14. The dynamic cypher authentication method as claimed in claim 11, wherein the step of generating the prompt password further comprises:
generating the prompt password according to a number corresponding to a time at which the trigger signal is generated.

15. The dynamic cryptographic method as claimed in claim 11, wherein the step of receiving the login password further comprises:
outputting the prompt password; and
inputting the login password by a user according to the prompt password.

16. The dynamic cypher authentication method as claimed in claim 11, wherein the step of receiving the operator password further comprises:
connecting an authentication IC (Integrated Circuit) card; and
receiving the operator password according to the authentication IC card.

17. The dynamic cypher authentication method as claimed in claim 11, wherein the step of receiving the operator password further comprises:
connecting an authentication IC card; and
determining whether to authorize the login request on the electronic device according to the authentication IC card.

18. The dynamic cypher authentication method as claimed in claim 11, further comprising:
selecting setting the operator password or a second password mode by a user.

19. The dynamic cypher authentication method as claimed in claim 18, wherein the second password mode is provided for inputting a fixed password.
